(19) United States
(12) Patent Application Publication
(10) Pub. No.: US 2026/0121113 A1
(43) Pub. Date: Apr. 30, 2026

(54) HALIDE SOLID ELECTROLYTE, POSITIVE ELECTRODE MATERIAL, AND BATTERY

(71) Applicant: Panasonic Intellectual Property Management Co., Ltd., Osaka (JP)

(72) Inventor: Eiichi KOGA, Hokkaido (JP)

(21) Appl. No.: 19/429,500

(22) Filed: Dec. 22, 2025

Related U.S. Application Data
(63) Continuation of application No. PCT/JP2024/020795, filed on Jun. 6, 2024.

(30) Foreign Application Priority Data
Jun. 29, 2023 (JP) 2023-107592

(51) Int. Cl. H01M 10/0562; H01M 10/052

(52) U.S. Cl. CPC H01M 10/0562; H01M 10/052; H01M 2300/008

(57) ABSTRACT

A halide solid electrolyte contains Li, Al, M, and X. M is at least one element selected from metal elements (excluding Li and Al) and metalloid elements, and X is at least one selected from F, Cl, Br, and I. The solid electrolyte includes a first particle group of first particles made of compound A containing Al and X, and a second particle group of second particles made of compound B not containing Al but containing M and X. In the first particle group, a coefficient of variation CV_{Al} (CV_{Al}=(σ_{Al}/A_{Al})×100) obtained using a standard deviation σ_{Al} and an average value A_{Al} of a mass ratio Al/X is 10% or less. In the second particle group, a coefficient of variation CV_{M} (CV_{M}=(σ_{M}/A_{M})×100) obtained using a standard deviation σ_{M} and an average value A_{M} of a mass ratio M/X is 20% or less.

This application is a continuation of PCT/JP2024/020795 filed on Jun. 6, 2024, which claims foreign priority of Japanese Patent Application No. 2023-107592 filed on Jun. 29, 2023, the entire contents of both of which are incorporated herein by reference.

### BACKGROUND OF THE INVENTION

### 1. Field of the Invention

The present disclosure relates to a halide solid electrolyte, a positive electrode material, and a battery.

### 2. Description of Related Art

WO 2021/186809 (hereinafter, Patent Literature 1) discloses a halide-based solid electrolyte material containing Li, Al, Ti, and F. In addition, WO 2021/187391 (hereinafter, Patent Literature 2) discloses a halide-based solid electrolyte material as a solid electrolyte material that coats the surface of a positive electrode active material.

### SUMMARY OF THE INVENTION

The present disclosure aims to provide a halide solid electrolyte having excellent ionic conductivity and reliability.

The halide solid electrolyte of the present disclosure is a halide solid electrolyte containing: Li; Al; M; and X, wherein
the M is at least one element selected from the group consisting of metal elements (excluding Li and Al) and metalloid elements,
the X is at least one selected from the group consisting of F, Cl, Br, and I,
the halide solid electrolyte includes
   a first particle group consisting of first particles made of a compound A containing Al and the X, and
   a second particle group consisting of second particles made of a compound B not containing Al but containing the M and the X
in the first particle group, a coefficient of variation CV_{Al} obtained by the following mathematical formula (A) using a standard deviation σ_{Al} of a ratio Al/X of a mass of Al to a mass of the X and an average value A_{Al} of the ratio Al/X is 10% or less, and
in the second particle group, a coefficient of variation CV_{M} obtained by the following mathematical formula (B) using a standard deviation σ_{M} of a ratio M/X of a mass of the M to a mass of the X and an average value A_{M} of the ratio M/X is 20% or less,

CV_{Al}=(σ_{Al}/A_{Al})×100, mathematical formula (A):

CV_{M}=(σ_{M}/A_{M})×100. mathematical formula (B):

The present disclosure provides a halide solid electrolyte having excellent ionic conductivity and reliability.

### BRIEF DESCRIPTION OF THE DRAWINGS

FIG. 1 illustrates a schematic diagram of the microstructure of a halide solid electrolyte according to a first embodiment of the present disclosure.

FIG. 2 is a flowchart of a production method for the halide solid electrolyte according to the first embodiment of the present disclosure.

FIG. 3 is a flowchart of a production method for a solid electrolyte according to Modification 1.

FIG. 4 illustrates a cross-sectional view of a battery 1000 according to a second embodiment.

FIG. 5 is a flowchart of a production method for a halide solid electrolyte of Example 1.

### DETAILED DESCRIPTION

Hereinafter, embodiments of the present disclosure will be specifically described with reference to the drawings.

The embodiments described below are all comprehensive or specific examples. The numerical values, shapes, materials, components, etc., shown in the following embodiments are examples, and are not intended to limit the present disclosure. In addition, among the components in the following embodiments, the components that are not described in the independent claims that represent broadest concepts are described as discretionary components.

### First Embodiment

A halide solid electrolyte according to a first embodiment of the present disclosure contains Li, Al, M, and X. Here, M is at least one element selected from the group consisting of metal elements (excluding Li and Al) and metalloid elements, and X is at least one selected from the group consisting of F, Cl, Br, and I.

The halide solid electrolyte according to the present embodiment includes a first particle group consisting of first particles made of a compound A containing Al and X, and a second particle group consisting of second particles made of a compound B not containing Al but containing M and X.

In the first particle group, a coefficient of variation CV_{Al} obtained by the following mathematical formula (A) using a standard deviation σ_{Al} of a ratio Al/X of the mass of Al to the mass of X and an average value A_{Al} of the ratio Al/X is 10% or less.

In the second particle group, a coefficient of variation CV_{M} obtained by the following mathematical formula (B) using a standard deviation σ_{M} of a ratio M/X of the mass of M to the mass of X and an average value A_{M} of the ratio M/X is 20% or less. Here, the mass of M is the total of the masses of all elements included as M when a plurality of elements are included as M.

CV_{Al}=(σ_{Al}/A_{Al})×100 Mathematical formula (A):

CV_{M}=(σ_{M}/A_{M})×100 Mathematical formula (B):

Owing to having the above configuration, the halide solid electrolyte according to the present embodiment has excellent ionic conductivity. Furthermore, the halide solid electrolyte according to the present embodiment can also have excellent stability (e.g., heat resistance and atmospheric resistance) and high reliability. Therefore, the halide solid electrolyte according to the present embodiment can have excellent ionic conductivity and reliability. For example, when the coefficient of variation CV_{Al} is 10% or less and the coefficient of variation CV_{M} is 20% or less, the halide solid electrolyte according to the present embodiment can achieve a high ionic conductivity of, for example, 1 μS/cm or more.

The identification of the first particles and the second particles included in the halide solid electrolyte (i.e., the identification of whether Al is included or not), the masses of Al and X in the first particles, and the masses of M and X in the second particles can be determined by elemental analysis using energy dispersive X-ray spectroscopy (EDS) or an electron probe microanalyzer (EPMA). For example, for a compacted powder of the halide solid electrolyte, a cross-section of the compacted powder is formed by an ion polisher or the like, and a plurality of arbitrary spots having a spot diameter of, for example, 1 μm are set on the cross-section. For each of these spots, for example, by point analysis with EPMA, the identification of the first particle and the second particle and the masses of Al and X in the first particle and the masses of M and X in the second particle may be determined. For each spot identified as the first particle, the ratio Al/X of the mass of Al to the mass of X is determined from the results of elemental analysis. Similarly, for each spot identified as the second particle, the ratio M/X of the mass of M to the mass of X is determined from the results of elemental analysis. The standard deviation σ_{Al} and the average value A_{Al} of the ratio Al/X are determined using the results of the ratios Al/X for arbitrary 20 spots identified as the first particles, and the coefficient of variation CV_{Al} is calculated from these values using the above mathematical formula (A). Meanwhile, the standard deviation σ_{M} and the average value A_{M} of the ratio M/X are determined using the results of the ratios M/X for arbitrary 20 spots identified as the second particles, and the coefficient of variation CV_{M} is calculated from these values using the above mathematical formula (B).

In order to improve the ionic conductivity, in the halide solid electrolyte according to the present embodiment, the coefficient of variation CV_{Al} may be, for example, 9% or less, 8% or less, or 7% or less. In order to improve the ionic conductivity, in the halide solid electrolyte according to the present embodiment, the coefficient of variation CV_{M} may be, for example, 18% or less, 15% or less, or 12% or less.

The above ratio Al/X may be equal to or greater than (average value A_{Al}−3×standard deviation σ_{Al}) and equal to or less than (average value A_{Al}+3×standard deviation σ_{Al}). That is, in the halide solid electrolyte according to the present embodiment, a relational expression of A_{Al}−3σ_{Al}≤ratio Al/X≤A_{Al}+3σ_{Al} may be satisfied. Accordingly, particles having a composition with a low ionic conductivity are reduced, so that a halide solid electrolyte having higher ionic conductivity (e.g., 1.0 μS/cm or more, or 3.0 μS/cm or more) can be obtained.

The above ratio M/X may be equal to or greater than (average value A_{M}−3×standard deviation σ_{M}) and equal to or less than (average value A_{M}+3×standard deviation σ_{M}). That is, in the halide solid electrolyte according to the present embodiment, a relational expression of A_{M}−3σ_{M}≤ratio M/X≤A_{M}+3σ_{M} may be satisfied. Accordingly, particles having a composition with a low ionic conductivity are reduced, so that a halide solid electrolyte having higher ionic conductivity (e.g., 1.0 μS/cm or more, or 3.0 μS/cm or more) can be obtained.

The above ratio Al/X may be equal to or greater than (average value A_{Al}−3×standard deviation σ_{Al}) and equal to or less than (average value A_{Al}+3× standard deviation σ_{Al}) and the above ratio M/X be equal to or greater than (average value A_{M}−3×standard deviation σ_{M}) and equal to or less than (average value A_{M}+3×standard deviation σ_{M}). Accordingly, particles having a composition with a low ionic conductivity are reduced, so that a halide solid electrolyte having higher ionic conductivity (e.g., 1.0 μS/cm or more, or 3.0 μS/cm or more) can be obtained.

Hereinafter, the first particles, the second particles, the compound A, the compound B, and a production method for the halide solid electrolyte will be described in more detail.

### (First Particles and Second Particles)

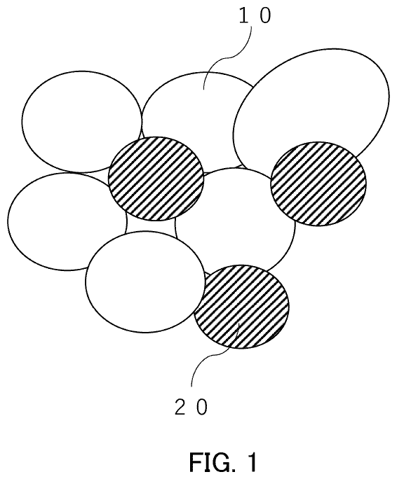

FIG. 1 illustrates a schematic diagram of the microstructure of the halide solid electrolyte according to the present embodiment. As shown in FIG. 1, the halide solid electrolyte according to the present embodiment includes a first particle 10 and a second particle 20. The halide solid electrolyte according to the present embodiment consists of an aggregate of multiple particles including a plurality of first particles 10 (i.e., first particle group) and a plurality of second particles 20 (i.e., second particle group). As described above, each first particle 10 is made of the compound A containing Al and X. In addition, each second particle 20 is made of the compound B not containing Al but containing M and X. In FIG. 1, the second particles 20 are hatched to distinguish the second particles 20 from the first particles 10.

The halide solid electrolyte according to the present embodiment may be in a powder state or may be a compacted powder.

The halide solid electrolyte according to the present embodiment may be, for example, a compacted powder formed from the first particles 10 and the second particles 20. In the case where the halide solid electrolyte according to the present embodiment is, for example, a compacted powder formed from the first particles 10 and the second particles 20, with the halide solid electrolyte according to the present embodiment, a solid electrolyte layer of a battery or a coating layer for active material particles that has excellent ionic conductivity and reliability can be realized.

The first particles 10 and the second particles 20 may each have, for example, an average particle diameter of 0.1 μm or more and 10 μm or less. The first particles 10 and the second particles 20 may each have, for example, a BET specific surface area of 0.2 m²/g or more and 20 m²/g or less. The particle shapes of the first particles 10 and the second particles 20 may each be any shape such as a spherical shape, a needle shape, or a flake shape.

At least one particle selected from the group consisting of the first particles 10 and the second particles 20 may include an amorphous phase. In this specification, the amorphous phase includes a phase having disturbed crystallinity, in other words, a distorted crystal phase, in addition to an amorphous phase. Owing to this configuration, a halide solid electrolyte that achieves both high ionic conductivity (e.g., 1.0 μS/cm or more) and low electronic conductivity (e.g., 0.01 μS/cm or less) can be obtained. In addition, in the particle, the amorphous phase portion generally becomes softer and more easily deformed than a crystal phase having high crystallinity. Therefore, in the halide solid electrolyte having the above configuration, when the first particle group and the second particle group are made into a compacted powder, an interface where the particles are in close contact with each other is easily formed, the halide solid electrolyte can be highly densified and is easily thinned, and further improvement of the ionic conductivity thereof can also be expected. Therefore, in the case where the halide solid electrolyte having the above configuration is used, for example, for a solid electrolyte layer of a battery, thinning of the solid electrolyte layer can be achieved, or the halide solid electrolyte can be suitably used for a coating layer for active material particles.

The volume of the amorphous phase included in the second particles 20 may be larger than the volume of the amorphous phase included in the first particles 10. According to this configuration, the ionic conductivity and the reliability can be further improved. In addition, according to the above configuration, since the halide solid electrolyte becomes softer and more easily deformed, the adhesion between the particles is improved, and the voids between the particles are reduced. Therefore, the halide solid electrolyte having the above configuration can be densified when made into a compacted powder. Accordingly, for example, in the case where the halide solid electrolyte is used for a solid electrolyte layer of a battery, the solid electrolyte layer can be densified, or the halide solid electrolyte can be suitably used for a coating layer for active material particles.

The amorphous phase included in the first particles 10 may have higher ionic conductivity than the amorphous phase included in the second particles 20. According to this configuration, the first particles 10 having higher ionic conductivity can be bonded by the softer second particles 20, so that high ionic conductivity can be obtained.

The amorphous phase may have lower electronic conductivity than the portion excluding the amorphous phase of the first particles 10 and the second particles 20. When the amorphous phase has lower electronic conductivity (e.g., 0.01 μS/cm or less) than the portion excluding the amorphous phase, a halide solid electrolyte having more excellent ionic conductivity is obtained.

In the case where the first particles 10 and/or the second particles 20 include an amorphous phase, for example, each particle surface layer may include a more amorphous phase than the particle interior. As described above, the amorphous phase generally increases softness compared to a crystal phase having high crystallinity. Therefore, when the more amorphous phase is included in the particle surface, the bondability (i.e., adhesion) between the particles also becomes stronger. Therefore, owing to the configuration where the more amorphous phase is included in the particle surface, the halide solid electrolyte according to the present embodiment can achieve densification of a compacted powder microstructure and improvement of the mechanical strength of a compacted powder.

In addition, in the first particles 10 and the second particles 20, a region including the amorphous phase (e.g., the particle surface layer) may have higher ionic conductivity and lower electronic conductivity than a region not including the amorphous phase (e.g., the particle interior). For example, the ionic conductivity of the region including the amorphous phase may be, for example, 1 μS/cm or more. The electronic conductivity of the region including the amorphous phase may be, for example, 0.01 μS/cm or less. With the halide solid electrolyte including the first particles 10 and the second particles 20 having such a configuration, a solid electrolyte that is dense in a compacted powder, has high ionic conductivity and a low electronic conductivity, and is useful for enhancing the performance of a battery, can be formed. The amorphous region included in the particle surface layer can become a joint interface between the particles in a compacted powder, forming a network that is three-dimensionally structured in a mesh-like shape with high ionic conductivity (e.g., 1 μS/cm or more) and low electronic conductivity (e.g., 0.01 μS/cm or less). Such differences in crystallinity between the particle interior, the particle surface layer, and the particle interface, can be observed as images of regions having high regularity of lattice images and disturbed regions of the lattice images using a high-resolution transmission electron microscope (TEM). In addition, the mechanical strength and the electrical properties within the particles can be evaluated using mechanical strength measurements such as Micro-Vickers, nano-probers used for semiconductor evaluation, or the like.

As described above, the amorphous nature formed mainly in the particle surface layer is created by mechanochemical treatment using a ball mill with general zirconia balls, from the particle surface layer on which impact directly acts. Amorphization of the surface layer proceeds preferentially over the particle interior, making it easier for the particles to bond together and reducing inter-particle friction during a pressing process. The mechanochemical treatment method and the zirconia balls, which are pulverizing media, are not limited, and any hard material that is difficult to contaminate and that enables amorphization, such as alumina, may be used.

It is preferable that the first particles 10 and the second particles 20 having different compositions as described above are uniformly dispersed.

The dispersibility of the first particles 10 and the second particles 20 can be observed, for example, through elemental analysis (area analysis or point analysis) using EDS or EPMA, or the like, on a cross-section of a compacted powder by an ion polisher or the like.

### (Compound A and Compound B)

As described above, the first particles 10 are made of the compound A, and the second particles 20 are made of the compound B. The compound A contains Al and X. The compound B does not contain Al but contains M and X.

The compound A may be represented by the following composition formula (1), and the compound B may be represented by the following composition formula (2).

Li₃(Al_{1-y1}M_{y1})X₆ Composition formula (1):

Li₂MX₆ Composition formula (2):

In the composition formula (1), y1 satisfies 0≤y1<1.

In the case where the compound A is represented by the above composition formula (1), the average composition of the compound A constituting each first particle 10 may be represented by the above composition formula (1), or the compound A for all the first particles 10 may be represented by the above composition formula (1). Here, the average composition of the compound A constituting each first particle 10 can be obtained using the results of elemental analysis with EDS or EPMA when identifying the above-described first particles and second particles. For example, for arbitrary 20 spots identified as the first particles 10, the average composition of the compound A for the first particles 10 can be obtained from the results of elemental analysis.

In the case where the compound B is represented by the above composition formula (2), the average composition of the compound B constituting each second particle 20 may be represented by the above composition formula (2), or the compound B for all the second particles 20 may be represented by the above composition formula (2). Here, the average composition of the compound B constituting each second particle 20 can be obtained using the results of elemental analysis with EDS or EPMA when identifying the above-described first particles and second particles. For example, for arbitrary 20 spots identified as the second particles 20, the average composition of the compound B for the second particles 20 can be obtained from the results of elemental analysis.

According to the above configuration, a halide solid electrolyte having further improved reliability can be obtained by a mixed structure of the compound A and the compound B having a high Li ion content and high ionic conductivity.

Thus, the two compounds A and B, which have different compositions, have different mechanical properties, thermal expansion properties, and heat resistance, etc. In addition, the temperature dependencies for these characteristics do not match either. Therefore, in the case where the halide solid electrolyte according to the present embodiment is made into a compacted powder, particles having different characteristics such as mechanical properties, thermal expansion properties, and heat resistance are dispersed within the compacted powder structure, so that critical destruction and degradation are suppressed. This is presumed to be because the damage caused by the dispersion of particles having different characteristics becomes sporadic, thereby preventing sudden destruction and making it difficult for characteristics degradation to manifest. Thus, the halide solid electrolyte according to the present embodiment, which includes the two compounds A and B having different compositions, achieves high ionic conductivity while enhancing bending strength, thermal shock resistance, and heat resistance, resulting in high reliability.

In the case where the halide solid electrolyte according to the present embodiment includes the first particle 10 made of the compound A represented by the composition formula (1) and the second particle 20 made of the compound B represented by the composition formula (2), the halide solid electrolyte according to the present embodiment can also be represented by the following composition formula (6).

xLi₃(Al_{1-y1}M_{y1})X₆-(1-x)Li₂MX₆ (0<x<1) Composition formula (6):

Here, in the composition formula (6), x satisfies 0<x<1.

The compound A may be represented by the following composition formula (3).

Li₃AlX₆ Composition formula (3):

According to the above configuration, a halide solid electrolyte having further improved reliability can be obtained by a mixed structure of the compound A and the compound B having a high Li ion content and high ionic conductivity.

The first particle group may include particles including a first crystal phase represented by the following composition formula (4) and a second crystal phase represented by the following composition formula (5).

Li₃(Al_{1-y2}M_{y2})X₆ Composition formula (4):

Li₂MX₆ Composition formula (5):

In the composition formula (4), y2 satisfies 0≤y2<1.

In the above configuration, the first crystal phase and the second crystal phase are included in one particle. By including such particles, a halide solid electrolyte having improved reliability can be obtained.

In the above particles including the first crystal phase and the second crystal phase, the molar ratio of the first crystal phase to the total of the first crystal phase and the second crystal phase may be 0.05 or more and 0.95 or less. According to this configuration, a halide solid electrolyte having higher ionic conductivity (e.g., 1.0 μS/cm or more) can be obtained.

X may include F. According to this configuration, due to the strong bond between the most electronegative fluoride ion and other cations, a halide solid electrolyte having excellent stability (e.g., electrochemical stability and heat resistance) can be obtained. Accordingly, the variation in characteristics during the production process is suppressed, and thus a battery having good performance and excellent reliability can be obtained. For example, in atmospheric air, the ionic conductivity and the particle form (e.g., BET specific surface area, etc.) are stable, for example, up to 250° C. or higher and 300° C. or lower, and excellent heat resistance is obtained. Therefore, the degradation of the characteristics of the solid electrolyte, for example, due to drying during slurry coating, or due to heat generation by friction during hot pressing (e.g., during pressing when integrating a positive electrode layer, a solid electrolyte layer, and a negative electrode layer of a battery or when stacking cells) or during coating of an active material, is suppressed.

M may include Ti. Owing to this configuration, a halide solid electrolyte having higher ionic conductivity can be obtained. In addition, by including Ti, the solid-phase reaction temperature can be lowered (e.g., to 750° C. or lower), that is, an effect of promoting the reaction can be obtained. Therefore, a homogeneous halide solid electrolyte having excellent ionic conductivity can be obtained.

In the above composition formula (1), M may include Ti, and y1 may satisfy 0≤y1≤0.3. Owing to this configuration, a halide solid electrolyte having higher ionic conductivity can be obtained.

In the above composition formula (4), M may include Ti, and y2 may satisfy 0≤y2≤0.3. Owing to this configuration, a halide solid electrolyte having higher ionic conductivity can be obtained.

The compound A represented by the composition formula (3) may have a monoclinic crystal structure. Owing to this configuration, a halide solid electrolyte having higher ionic conductivity (e.g., 1.0 μS/cm or more) can be obtained.

In the above particles including the first crystal phase and the second crystal phase, the first crystal phase may have an orthorhombic crystal structure. Owing to this configuration, a halide solid electrolyte having higher ionic conductivity (e.g., 3.0 μS/cm or more) can be obtained. In this case, M may include Ti. When M includes Ti in this case, a halide solid electrolyte having even higher ionic conductivity (e.g., 6.0 μS/cm or more) can be obtained.

### (Characteristics of Halide Solid Electrolyte)

The compacted powder of the halide solid electrolyte according to the present embodiment can be used, for example, for a solid electrolyte layer of a battery, a coating layer coating an active material of a battery, a composite material of an electrode layer, etc. With the halide solid electrolyte according to the present embodiment, a highly dense compacted powder (e.g., with a relative density of 95% or more) can be formed by increasing fillability. Accordingly, a compacted powder having high ionic conductivity and excellent mechanical performance (e.g., high bending strength and high impact resistance) is obtained. Meanwhile, by reducing the relative density of the solid electrolyte (e.g., to 90% or less), the heat capacity of the solid electrolyte is decreased, so that thermal shock resistance can be enhanced. The compactness of the compacted powder of such a solid electrolyte can be controlled, for example, by a pressure for forming the compacted powder. The halide solid electrolyte according to the present embodiment is a material having excellent adhesion between particles, and the density thereof can be controlled in a wide range according to the intended application. In addition, in the case where the solid electrolyte of the present embodiment is used for a coating layer of an active material, densification can be achieved by increasing the shear stress during coating of the active material. The shear stress is, for example, 29.4 MPa or more and 980 MPa or less. Moreover, when the first particles 10 and/or the second particles 20 include an amorphous phase, the solid electrolyte becomes softer and the adhesion between the particles can be enhanced. Furthermore, an effect of suppressing the destruction of active material particles due to stress during coating is obtained, and an effect of suppressing characteristics degradation due to the destruction of active material particles is also obtained. In addition, the friction between the particles is also reduced, so that heat generation between the particles during pressing or coating is also suppressed. Therefore, thermal alternations of the solid electrolyte and the active material can be suppressed, and characteristics degradation and changes in particle shape can be suppressed.

The melting point of the compound A represented by the composition formula (1) is, for example, 750° C. or higher and 800° C. or lower in atmospheric air. The melting point of the compound B represented by the composition formula (2) is, for example, around 700° C. In this case, when the compound A and the compound B are compared, the compound B having a lower melting point tends to be softer. Therefore, when the compound A and the compound B are included together and pulverization (amorphization) treatment is performed thereon in the same batch, amorphization of the compound B tends to proceed more easily. Therefore, in this case, the amorphous phase of the particle surface layer of the compound B is large, or the second particles 20 made of the compound B include more amorphized particles. Therefore, in the solid electrolyte obtained by mixing the first particles 10 made of the compound A and the second particles 20 made of the compound B and performing mechanochemical treatment thereon, amorphization of the particle surface tends to proceed in the second particles 20, resulting in an effect of improving the adhesion of a joint interface with particles. For example, in the compacted powder, an effect in which the particles of the soft compound B preferentially become deformed to fill the voids between the particles of the compound A, is obtained. Thus, by including the second particles 20 made of the compound B in the first particles 10 made of the compound A, it becomes easier to obtain a solid electrolyte that is dense and has excellent mechanical performance. By including such first particles 10 made of the compound A and such second particles 20 made of the compound B and having the coefficient of variation CV_{Al} and the coefficient of variation CV_{M} with which high ionic conductivity is obtained, a solid electrolyte that is dense and is less likely to cause defects can be formed. For example, by mixing a powder of Li₃AlF₆ having a compacted density of 1.942 g/cm³ and a powder of Li₂TiF₆ at a molar ratio of 75:25, the density is improved to 1.988 g/cm³.

### (Production Method for Halide Solid Electrolyte)

The halide solid electrolyte of the present embodiment can be produced, for example, by the following method.

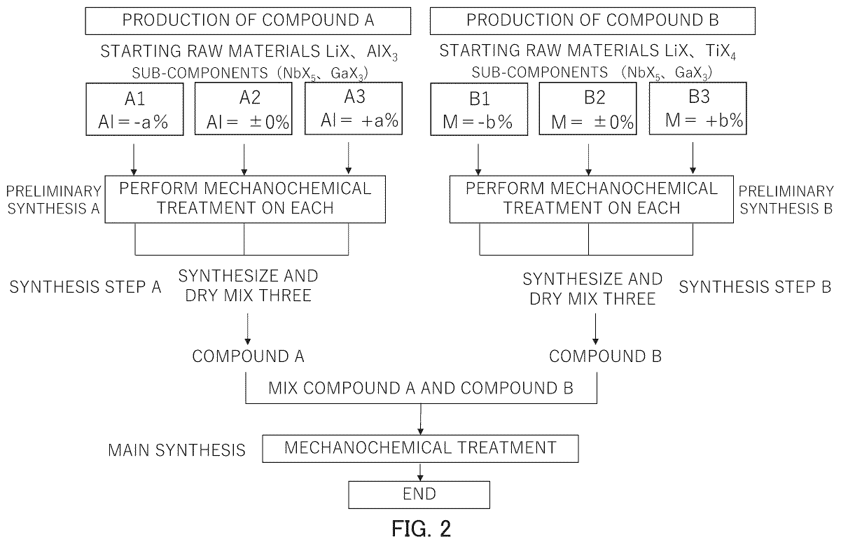

FIG. 2 is a flowchart of a production method for the halide solid electrolyte according to the embodiment of the present disclosure. Hereinafter, the production method for the halide solid electrolyte according to the present embodiment will be described with reference to FIG. 2.

A plurality of batches in which an average composition becomes a target compound A composition, for example, has the composition formula (1) and Al components thereof are slightly different from each other, are synthesized to produce the first particles 10 made of the compound A. Meanwhile, a plurality of batches in which an average composition becomes a target compound B composition, for example, has the composition formula (2) and M components thereof are slightly different from each other, are synthesized to produce the second particles 20 made of the compound B. By mixing the obtained first particles 10 and second particles 20 at a predetermined ratio, the halide solid electrolyte of the present embodiment can be synthesized. The synthesis method is not limited to this, it is sufficient that the solid electrolyte of the present embodiment is finally synthesized, and the synthesis route is not limited to that of the present embodiment.

An example of a specific method for producing the first particles 10 is as follows.

A plurality of batches in which an Al component is slightly varied are preliminarily synthesized such that an average composition becomes the target compound A composition. The average composition of the plurality of preliminarily synthesized batches becomes the target compound A composition. As an example, three batches A1, A2, and A3 having Al components slightly different from each other are prepared as shown in FIG. 2. The batch Al is obtained by mixing starting raw materials such that the composition has Al at −a % from the target compound A composition, that is, such that the mixing ratio of the starting raw materials is a ratio in which Al is reduced by a % in molar ratio compared to the amount of Al charged when synthesizing the target composition. The batch A2 is obtained by mixing the starting raw materials at a ratio that achieves the target compound A composition. That is, in the batch A2, the change in Al from the target composition is ±0%. The batch A3 is obtained by mixing the starting raw materials such that the composition has Al at +a % from the target compound A composition, that is, such that the mixing ratio of the starting raw materials is a ratio in which Al is increased by a % in molar ratio compared to the amount of Al charged when synthesizing the target composition. “a” can be adjusted, for example, in the range of 0.001% or more and 10% or less. Starting raw materials serving as Li, Al, and M sources are charged at respective ratios, and preliminary synthesis A (synthesis of batches A1, A2, and A3) is performed, for example, by a mechanochemical synthesis method. The form of the starting raw materials may be, for example, halides such as fluorides thereof (e.g., LiF, AlF₃, fluoride of M) but is not limited to the halides such as the fluorides. For example, the form may be any form as long as the solid electrolyte according to the present embodiment can be synthesized, and any raw material form such as oxides, carbonates, or fluorinated oxides can be used. Sub-components (i.e., Nb and Ga components) may be included in the starting raw materials, whereby a synthesis reaction (e.g., LiF+AlF₃→Li₃AlF₆) can be promoted.

After the batches A1, A2, and A3 are preliminarily synthesized, the batches A1, A2, and A3 are weighed at a molar ratio of A1:A2:A3=1:1:1 and are dry mixed uniformly, for example, for about 30 minutes using a mortar and a pestle (synthesis step A). Through this synthesis step A, a powder whose average composition is the target compound A composition is obtained. This powder corresponds to the first particles 10. The particle diameter of the powder may be any particle diameter as long as the powder is easily handled during the production process, and, for example, the average particle diameter thereof may be 0.5 μm or more and 3.0 μm or less. Although the example of synthesis with the three batches A1, A2, and A3 has been taken, the synthesis is not limited to this, and the number of batches may be four or more.

An example of a specific method for producing the second particles 20 is as follows.

A plurality of batches in which an M component is slightly varied are preliminarily synthesized such that an average composition becomes the target compound B composition. The average composition of the plurality of preliminarily synthesized batches becomes the target compound B composition. As an example, three batches B1, B2, and B3 having M components slightly different from each other are prepared as shown in FIG. 2. The batch B1 is obtained by mixing starting raw materials such that the composition has M at −b % from the target compound B composition, that is, such that the mixing ratio of the starting raw materials is a ratio in which M is reduced by b % in molar ratio compared to the amount of M charged when synthesizing the target composition. The batch B2 is obtained by mixing the starting raw materials at a ratio that achieves the target compound B composition. That is, in the batch B2, the change in M from the target composition is ±0%. The batch B3 is obtained by mixing the starting raw materials such that the composition has M at +b % from the target compound B composition, that is, such that the mixing ratio of the starting raw materials is a ratio in which M is increased by b % in molar ratio compared to the amount of M charged when synthesizing the target composition. “b” can be adjusted, for example, in the range of 0.001% or more and 15% or less. Starting raw materials serving as Li and M sources are charged at respective ratios, and preliminary synthesis B (synthesis of batches B1, B2, and B3) is performed, for example, by a mechanochemical synthesis method. The form of the starting raw materials may be, for example, fluorides thereof (e.g., LiF and fluoride of M) but is not limited to the fluorides. For example, the form may be any form as long as the solid electrolyte according to the present embodiment can be synthesized, and any raw material form such as oxides, carbonates, or fluorinated oxides can be used. Sub-components (i.e., Nb and Ga components) may be included in the starting raw materials, whereby a synthesis reaction (e.g., LiF+AlF₃→Li₃AlF₆) can be promoted.

After the batches B1, B2, and B3 are preliminarily synthesized, the batches B1, B2, and B3 are weighed at a molar ratio of B1:B2:B3=1:1:1 and are dry mixed uniformly, for example, for about 30 minutes using a mortar and a pestle (synthesis step B). Through this synthesis step B, a powder whose average composition is the target compound B composition is obtained. This powder corresponds to the second particles 20. The particle diameter of the powder may be any particle diameter as long as the powder is easily handled during the production process, and, for example, the average particle diameter thereof may be 0.5 μm or more and 3.0 μm or less. Although the example of synthesis with the three batches B1, B2, and B3 has been taken, the synthesis is not limited to this, and the number of batches may be four or more.

The first particles 10 made of the compound A and obtained through the above synthesis step A and the second particles 20 made of the compound B and obtained through the above synthesis step B are weighed at a predetermined ratio (e.g., first particles 10:second particles 20=7:3 (molar ratio)) and are dry mixed uniformly, for example, for a time of 20 minutes or longer and 40 minutes or shorter using a general alumina mortar and pestle, as in the mixing in the synthesis step A and the synthesis step B. Then, the mixture is placed together with zirconia balls (diameter: 0.5 mm or more and 3 mm or less, 100 g or more and 400 g or less) in a planetary ball mill (capacity: 300 mL), and dry mechanochemical treatment (e.g., 20 hours or longer and 60 hours or shorter) is performed as a main synthesis step, thereby synthesizing a solid electrolyte having amorphous nature and including compositional variations of Al and M. Thus, the solid electrolyte according to the present embodiment can be synthesized.

In the main synthesis step, sub-components (Nb and Ga components (e.g., NbF₅ and GaF₃)) may be included. For example, the sub-components may be included in a divided manner during the synthesis of the compound A, during the synthesis of the compound B, and during main mixing of the compound A (i.e., first particles 10) and the compound B (i.e., second particles 20). By adding and including the sub-components in a divided manner, an effect in which the sub-components are uniformly dispersed within the solid electrolyte is obtained. The sub-components (Nb and Ga) provide an effect of promoting solid-phase reactions (reactions for synthesizing the compound A and the compound B from the starting raw materials). The sub-components are preferably in the form of fine particles to prevent generation of undesired precipitate phases. For example, it is desirable that the sub-components should be particles (e.g., having an average particle diameter of 0.1 μm or more and 1 μm or less) smaller than the starting raw materials (e.g., LiF, AlF₃, and TiF₄).

In the above example, the fluorides are used as the starting raw materials, but halides corresponding to the halogen elements included in X can be used.

The number of split batches is not limited to three, only has to be two or more, and may be four or more. In addition, in the dry mixing or the dry mechanochemical treatment, the powder does not have fluidity like a liquid, and thus, by setting the number of split batches as a plural number (and increasing the number of split batches), it is easy to synthesize a solid electrolyte that has a limited composition range or is homogeneous. However, increasing the number of split batches leads to a decrease in workability, and thus the number of split batches may also be set in view of productivity. The number of split batches may differ between the compound A and the compound B.

As described above, the solid electrolyte according to the present embodiment can be synthesized. If synthesis is performed with all starting raw materials combined into one batch as described in Patent Literatures 1 and 2, it may be difficult to achieve homogenization, and due to compositional unevenness, undesired precipitate phases are likely to be generated, leading to greater compositional variation.

The diameter of the zirconia balls can be any size for adjusting the powder amount and pulverizing force.

The mixing of the compound A and the compound B, which include composition differences, is not limited to mixing using a ball mill and may be, for example, wet mixing using a V blender, a disperser mill with a solvent such as ethanol, or the like. The dispersion state and composition differences (Al and Ti) of the compound A and the compound B in the solid electrolyte can be evaluated, for example, by elemental analysis (area analysis or point analysis) with EPMA or EDS.

In the above example, the halides such as the fluorides are used as the starting raw materials. However, as Modification 1 of the production method, oxides may be used as starting raw materials, and precursors of the oxides for the compound A and precursors of the oxides for the compound B may be halogenated (fluorinated). In the following example, a case where fluorination treatment is performed as halogenation will be described.

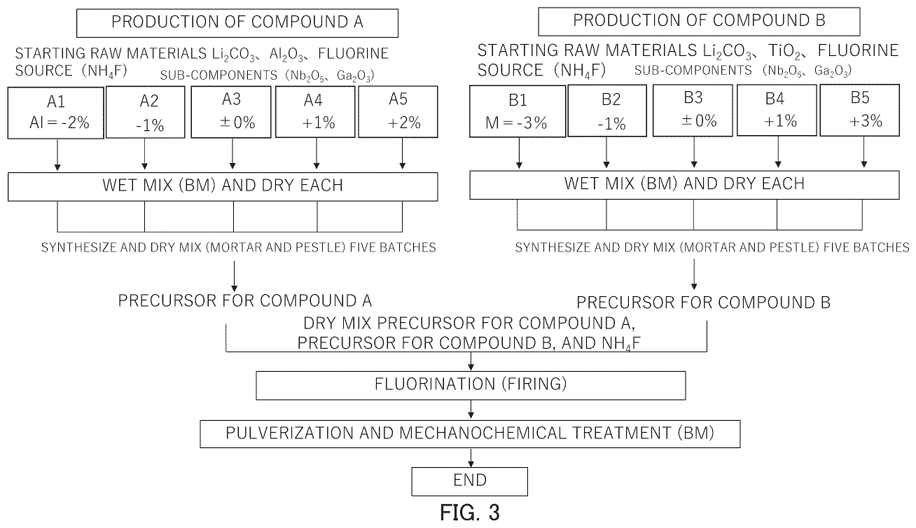

FIG. 3 is a flowchart of a production method for a solid electrolyte according to Modification 1. Modification 1 differs in that, as the compound A and the compound B, which include composition differences, from chemically high-purity oxide and carbonate powders such as Li₂CO₃, TiO₂, and Al₂O₃ as starting raw materials, oxide precursors (compound A and compound B) are synthesized and then mixed with NH₄F powder, and heat treatment is performed, thereby fluorinating the oxide precursors to synthesize the solid electrolyte.

Five batches in which an Al component is slightly varied are preliminarily synthesized using Li₂CO₃ and Al₂O₃ as the precursors for the compound A (with a composition ratio of Li₃AlO₃) (A1 to A5 precursors), and then a plurality of preliminary synthesis batches are synthesized (mixed into one) to obtain a precursor for the compound A that includes an Al composition difference with an average composition being A (with a composition ratio of Li₂AlO₃).

Specifically, as for the five composition components, Al=−2%, −1%, ±0%, +1%, and +2%, as in the embodiment. The starting raw materials are weighed in a normal atmospheric environment (e.g., at a temperature of 22° C. to 26° C. and a humidity of 30% to 50%) at a scale of 30 g so as to achieve the respective ratios of these components, are wet mixed and pulverized using a 600 ml-capacity ball mill (with φ1-mm zirconia balls and pure water (60 ml)) (20 h), and are then air-dried in a drier (at 200° C. for 20 h) to obtain powders of preliminary syntheses A1, A2, A3, A4, and A5, which are then dry mixed (using a mortar and pestle) to obtain a precursor powder for the compound A.

Meanwhile, five batches in which a Ti component is slightly varied are preliminarily synthesized using Li₂CO₃ and TiO₂ (e.g., anatase type) as the precursors for the compound B (with a composition ratio of Li₂TiO₃) (B1 to B5 precursors), and then a plurality of preliminary synthesis batches are dry synthesized (mixed into one) to obtain a precursor for the compound B that includes a Ti composition difference with an average composition being B (with a composition ratio of Li₂TiO₃).

Specifically, as for the five composition components, Ti=−3%, −1%, ±0%, +1%, and +3%, as in the embodiment. The starting raw materials are weighed in a normal atmospheric environment at a scale of 30 g so as to achieve the respective ratios of these components, are wet mixed and pulverized using a 600 ml-capacity ball mill (with φ1-mm zirconia balls and pure water (60 ml)) (20 h), and are then air-dried in a drier (at 200° C. for 20 h) to obtain precursor powders of preliminary syntheses B1, B2, B3, B4, and B5. The obtained powders of preliminary syntheses B1, B2, B3, B4, and B5 are dry mixed (using a mortar and pestle) to obtain a precursor powder for the compound B.

Then, the precursor powder for the compound A (preliminary syntheses A1, A2, A3, A4, and A5) and the precursor powder for the compound B (preliminary syntheses B1, B2, B3, B4, and B5) are dry mixed at a predetermined ratio for about 10 minutes using a mortar and a pestle to obtain a precursor mixed powder in which the compound A and the compound B are mixed. Next, a predetermined amount of NH₄F powder as a fluorine source and the precursor mixed powder for the compound A and the compound B are weighed at respective predetermined ratios thereof to a total of 30 g, and are dry mixed for about 10 minutes using a mortar and a pestle.

Then, the powder mixed with NH₄F (NH₄F+compound A precursor+compound B precursor) is placed in a high-purity (SSA-H) alumina crucible and is converted into fluorides by performing heat treatment at 330° C. for 5 h in a nitrogen atmosphere using a general electric furnace. Then, on the obtained fluoride, mechanochemical treatment is performed as in the embodiment.

Thus, the solid electrolyte of the present embodiment is obtained by the production method of Modification 1. The diameter of the zirconia balls can be any size for adjusting the powder amount and pulverizing force. Furthermore, the precursor may be a fluoride oxide (e.g., TiF₂O).

The fluorination method is not limited to the above method, and fluorination may be performed by performing heat treatment on a fluorine source to generate fluorine gas and bringing the fluorine gas into contact with an object to be fluorinated.

Specifically, the precursor mixed powder for the compound A and the compound B is on a mesh such as a nickel mesh with fine openings, the fluorine source (ammonium fluoride) is below the mesh, and the precursor mixed powder and the fluorine source are not in direct contact with each other. Fluorine gas may be generated by performing heat treatment and may pass through the mesh to synthesize the precursor mixed powder for the compound A and the compound B into the fluorides. As the fluorine source, any material that is thermally decomposed may be used. In particular, since the mixed powder and the fluorine source are not in direct contact with each other, the fluorine source may contain inorganic residues (e.g., CuF₂, etc., which emit F as a gas when heated). It is desirable to perform heat treatment in a nitrogen atmosphere or a reducing atmosphere to prevent oxidation of the nickel mesh, but heat treatment in atmospheric air is possible as long as this heat treatment is performed a few times.

### Second Embodiment

Hereinafter, a second embodiment will be described. The matters described in the first embodiment are omitted as appropriate.

A battery according to the second embodiment includes a positive electrode, an electrolyte layer, and a negative electrode. The electrolyte layer is provided between the positive electrode and the negative electrode.

At least one selected from the group consisting of the positive electrode, the electrolyte layer, and the negative electrode includes the halide solid electrolyte according to the first embodiment.

Owing to including the halide solid electrolyte according to the first embodiment, the battery according to the second embodiment has excellent charge and discharge characteristics.

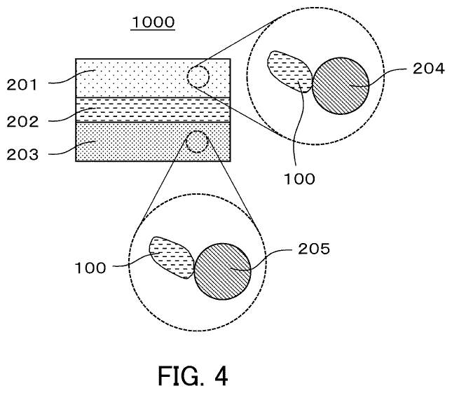

FIG. 4 illustrates a cross-sectional view of a battery 1000 according to the second embodiment.

The battery 1000 according to the second embodiment includes a positive electrode 201, an electrolyte layer 202, and a negative electrode 203. The electrolyte layer 202 is provided between the positive electrode 201 and the negative electrode 203.

The positive electrode 201 may include a positive electrode material including the halide solid electrolyte according to the first embodiment. The positive electrode 201 includes a positive electrode active material 204 and a solid electrolyte 100.

The electrolyte layer 202 includes an electrolyte material.

The negative electrode 203 includes a negative electrode active material 205 and the solid electrolyte 100.

The solid electrolyte 100 includes, for example, the halide solid electrolyte according to the first embodiment. The solid electrolyte 100 may be particles including the halide solid electrolyte according to the first embodiment as a main component. The particles including the halide solid electrolyte according to the first embodiment as a main component mean particles in which the component included in the largest amount in molar ratio is the halide solid electrolyte according to the first embodiment. The solid electrolyte 100 may be particles consisting of the halide solid electrolyte according to the first embodiment.

The positive electrode 201 includes a material capable of occluding and releasing metal ions (e.g., lithium ions). The material is, for example, the positive electrode active material 204.

Examples of the positive electrode active material 204 include a lithium-containing transition metal oxide, a transition metal fluoride, polyanion, a fluorinated polyanion material, a transition metal sulfide, a transition metal oxyfluoride, a transition metal oxysulfide, and a transition metal oxynitride. Examples of the lithium-containing transition metal oxide include Li(Ni, Co, Mn)O₂, Li(Ni, Co, Al)O₂, and LiCoO₂.

In the present disclosure, “(A, B, C)” means “at least one selected from the group consisting of A, B, and C”.

The shape of the positive electrode active material 204 is not limited to a specific shape. The positive electrode active material 204 may be particles. The positive electrode active material 204 may have a median diameter of 0.1 μm or more and 100 μm or less. In the case where the positive electrode active material 204 has a median diameter of 0.1 μm or more, the positive electrode active material 204 and the solid electrolyte 100 can be well dispersed in the positive electrode 201. Accordingly, the charge and discharge characteristics of the battery 1000 are improved. In the case where the positive electrode active material 204 has a median diameter of 100 μm or less, the diffusion rate of lithium in the positive electrode active material 204 improves. Accordingly, the battery 1000 can operate at a high power.

The positive electrode active material 204 may have a median diameter larger than that of the solid electrolyte 100. Accordingly, the positive electrode active material 204 and the solid electrolyte 100 can be well dispersed in the positive electrode 201.

In order to improve the energy density and power output of the battery 1000, the ratio of the volume of the positive electrode active material 204 to the total of the volume of the positive electrode active material 204 and the volume of the solid electrolyte 100 in the positive electrode 201 may be 0.30 or more and 0.95 or less.

A coating layer may be formed on at least a part of the surface of the positive electrode active material 204. The coating layer can be formed on the surface of the positive electrode active material 204, for example, before mixing a conductive additive and a binder. Examples of a coating material included in the coating layer include a sulfide solid electrolyte, an oxide solid electrolyte, and a halide solid electrolyte. In the case where the solid electrolyte 100 includes a sulfide solid electrolyte, the coating material may include the halide solid electrolyte according to the first embodiment to suppress oxidative decomposition of the sulfide solid electrolyte. In the case where the solid electrolyte 100 includes the halide solid electrolyte according to the first embodiment, the coating material may include an oxide solid electrolyte to suppress oxidative decomposition of the solid electrolyte. As the oxide solid electrolyte, lithium niobate having excellent high-potential stability may be used. By suppressing oxidative decomposition, an increase in overvoltage of the battery 1000 can be suppressed.

As described above, in the case where the positive electrode 201 includes a positive electrode material including the halide solid electrolyte according to the first embodiment, the positive electrode material may include the halide solid electrolyte according to the first embodiment as the solid electrolyte 100 or may include a coating material that coats the positive electrode active material 204.

In order to improve the energy density and power output of the battery 1000, the positive electrode 201 may have a thickness of 10 μm or more and 500 μm or less.

The electrolyte layer 202 includes an electrolyte material. The electrolyte material is, for example, a solid electrolyte. The solid electrolyte may include the halide solid electrolyte according to the first embodiment. The electrolyte layer 202 may be a solid electrolyte layer.

The electrolyte layer 202 may include 50 mass % or more of the halide solid electrolyte according to the first embodiment. The electrolyte layer 202 may include 70 mass % or more of the halide solid electrolyte according to the first embodiment. The electrolyte layer 202 may include 90 mass % or more of the halide solid electrolyte according to the first embodiment. The electrolyte layer 202 may consist only of the halide solid electrolyte according to the first embodiment.

Hereinafter, the halide solid electrolyte according to the first embodiment is referred to as first solid electrolyte. A solid electrolyte different from the first solid electrolyte is referred to as second solid electrolyte.

The electrolyte layer 202 may include not only the first solid electrolyte but also the second solid electrolyte. In the electrolyte layer 202, the first solid electrolyte and the second solid electrolyte may be uniformly dispersed. A layer consisting of the first solid electrolyte and a layer consisting of the second solid electrolyte may be stacked together along the stacking direction of the battery 1000.

The battery according to the second embodiment may include the positive electrode 201, a second electrolyte layer, a first electrolyte layer, and the negative electrode 203 in this order. Here, the solid electrolyte included in the first electrolyte layer may have a lower reduction potential than the solid electrolyte included in the second electrolyte layer. Accordingly, the solid electrolyte included in the second electrolyte layer can be used without being reduced. As a result, the charge and discharge efficiency of the battery 1000 can be improved. For example, in the case where the second electrolyte layer includes the first solid electrolyte, the first electrolyte layer may include a sulfide solid electrolyte to suppress reductive decomposition of the solid electrolyte. Accordingly, the charge and discharge efficiency of the battery 1000 can be improved. The second electrolyte layer may include the first solid electrolyte. The first solid electrolyte has high oxidation resistance, so that a battery having excellent charge and discharge characteristics can be realized.

The electrolyte layer 202 may consist only of the second solid electrolyte.

The electrolyte layer 202 may have a thickness of 1 μm or more and 1000 μm or less. In the case where the electrolyte layer 202 has a thickness of 1 μm or more, the positive electrode 201 and the negative electrode 203 are less likely to short circuit. In the case where the electrolyte layer 202 has a thickness of 1000 μm or less, the battery 1000 can operate at a high power.

Examples of the second solid electrolyte include Li₂MgX₄, Li₂FeX₄, Li(Al, Ga, In)X₄, Li₃(Al, Ga, In)X₆, and LiI, where X is at least one selected from the group consisting of F, Cl, Br, and I.

In order to improve the energy density and power output of the battery 1000, the electrolyte layer 202 may have a thickness of 1 μm or more and 1000 μm or less.

The negative electrode 203 includes a material capable of occluding and releasing metal ions (e.g., lithium ions). The material is, for example, the negative electrode active material 205.

Examples of the negative electrode active material 205 include a metal material, a carbon material, an oxide, a nitride, a tin compound, and a silicon compound. The metal material may be an elemental metal or an alloy. Examples of the metal material include lithium metal and a lithium alloy. Examples of the carbon material include a natural graphite, a coke, a semi-graphitized carbon, a carbon fiber, a spherical carbon, an artificial graphite, and an amorphous carbon. From the viewpoint of capacity density, preferred examples of the negative electrode active material include silicon (i.e., Si), tin (i.e., Sn), a silicon compound, and a tin compound.

The negative electrode active material 205 may be selected in consideration of the reduction resistance of the solid electrolyte material included in the negative electrode 203. For example, in the case where the negative electrode 203 includes the first solid electrolyte, the negative electrode active material 205 may be a material capable of occluding and releasing lithium ions at 0.27 V or more with respect to lithium. Examples of such a negative electrode active material include a titanium oxide, indium metal, and a lithium alloy. Examples of the titanium oxide include Li₄Ti₅O₁₂, LiTi₂O₄, and TiO₂. By using the above negative electrode active material, reductive decomposition of the first solid electrolyte included in the negative electrode 203 can be suppressed. As a result, the charge and discharge efficiency of the battery 1000 can be improved.

The shape of the negative electrode active material 205 is not limited to a specific shape. The negative electrode active material 205 may be particles. The negative electrode active material 205 may have a median diameter of 0.1 μm or more and 100 μm or less. In the case where the negative electrode active material 205 has a median diameter of 0.1 μm or more, the negative electrode active material 205 and the solid electrolyte 100 can be well dispersed in the negative electrode 203. Accordingly, the charge and discharge characteristics of the battery 1000 are improved. In the case where the negative electrode active material 205 has a median diameter of 100 μm or less, the diffusion rate of lithium in the negative electrode active material 205 improves. Accordingly, the battery 1000 can operate at a high power.

The negative electrode active material 205 may have a median diameter larger than that of the solid electrolyte 100. Accordingly, the negative electrode active material 205 and the solid electrolyte 100 can be well dispersed in the negative electrode 203.

In order to improve the energy density and power output of the battery 1000, the ratio of the volume of the negative electrode active material 205 to the total of the volume of the negative electrode active material 205 and the volume of the solid electrolyte 100 in the negative electrode 203 may be 0.30 or more and 0.95 or less.

In order to improve the energy density and power output of the battery 1000, the negative electrode 203 may have a thickness of 10 μm or more and 500 μm or less.

At least one selected from the group consisting of the positive electrode 201, the electrolyte layer 202, and the negative electrode 203 may include the second solid electrolyte for the purpose of increasing ionic conductivity, chemical stability, and electrochemical stability.

The second solid electrolyte may be a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

In the case where the electrolyte layer 202 includes the first solid electrolyte, the negative electrode 203 may include a sulfide solid electrolyte to suppress reductive decomposition of the solid electrolyte. By covering the negative electrode active material with the sulfide solid electrolyte which is electrochemically stable, contact of the first solid electrolyte with the negative electrode active material can be suppressed. As a result, the internal resistance of the battery 1000 can be reduced.

The second solid electrolyte may be an oxide solid electrolyte.

Examples of the oxide solid electrolyte include:
(i) a NASICON solid electrolyte such as LiTi₂(PO₄)₃ and element-substituted substances thereof;
(ii) a perovskite solid electrolyte such as (LaLi)TiO₃;
(iii) a LISICON solid electrolyte such as Li₁₄ZnGe₄O₁₆, Li₄SiO₄, and LiGeO₄ and element-substituted substances thereof;
(iv) a garnet solid electrolyte such as Li₇La₃Zr₂O₁₂ and element-substituted substances thereof; and
(v) Li₃PO₄ and N-substituted substances thereof.

As described above, the second solid electrolyte may be a halide solid electrolyte.

Examples of the halide solid electrolyte include Li₂MgX₄, Li₂FeX₄, Li(Al, Ga, In)X₄, Li₃(Al, Ga, In)X₆, and LiI, where X is at least one selected from the group consisting of F, Cl, Br, and I.

Another example of the halide solid electrolyte is a compound represented by LiₐMe_{b}Y_{c}Z₆, where a+mb+3c=6 and c>0 are satisfied. Me is at least one selected from the group consisting of metal elements other than Li and Y and metalloid elements. Z is at least one selected from the group consisting of F, Cl, Br, and I. The symbol m represents the valence of Me. The “metalloid elements” are B, Si, Ge, As, Sb, and Te. The “metal elements” are: all the elements included in Groups 1 to 12 of the periodic table (excluding hydrogen); and all the elements included in Groups 13 to 16 of the periodic table (excluding B, Si, Ge, As, Sb, Te, C, N, P, O, S, and Se).

In order to improve the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The halide solid electrolyte may be Li₃YCl₆ or Li₃YBr₆.

The second solid electrolyte may be an organic polymer solid electrolyte.

An example of the organic polymer solid electrolyte is a compound of a polymer compound with a lithium salt.

The polymer compound may have an ethylene oxide structure. A polymer compound having an ethylene oxide structure can contain a large amount of a lithium salt, and accordingly can further increase the ionic conductivity.

Examples of the lithium salt include LiPF₆, LiBF₄, LiSbF₆, LiAsF₆, LiSO₃F₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used.

In order to facilitate transfer of lithium ions and thereby improve the output characteristics of the battery, at least one selected from the group consisting of the positive electrode 201, the electrolyte layer 202, and the negative electrode 203 may include a nonaqueous electrolyte solution, a gel electrolyte, or an ionic liquid.

The nonaqueous electrolyte solution contains a nonaqueous solvent and a lithium salt dissolved in the nonaqueous solvent.

Examples of the nonaqueous solvent include a cyclic carbonate solvent, a linear carbonate solvent, a cyclic ether solvent, a linear ether solvent, a cyclic ester solvent, a linear ester solvent, and a fluorinated solvent. Examples of the cyclic carbonate solvent include ethylene carbonate, propylene carbonate, and butylene carbonate. Examples of the linear carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the linear ether solvent include 1,2-dimethoxyethane and 1,2-diethoxyethane. Examples of the cyclic ester solvent include γ-butyrolactone. Examples of the linear ester solvent include methyl acetate. Examples of the fluorinated solvent include fluoroethylene carbonate, methyl fluoropropionate, fluorobenzene, fluoroethyl methyl carbonate, and fluorodimethylene carbonate. One nonaqueous solvent selected from these may be used alone. Alternatively, a combination of two or more nonaqueous solvents selected from these may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used. The concentration of the lithium salt falls, for example, within a range from 0.5 mol/L to 2 mol/L.

As the gel electrolyte, a polymer material impregnated with a nonaqueous electrolyte solution can be used. Examples of the polymer material include polyethylene oxide, polyacrylonitrile, polyvinylidene fluoride, polymethyl methacrylate, and a polymer having an ethylene oxide bond.

Examples of cations contained in the ionic liquid include:
(i) aliphatic linear quaternary salts such as tetraalkylammoniums and tetraalkylphosphoniums;
(ii) aliphatic cyclic ammoniums such as pyrrolidiniums, morpholiniums, imidazoliniums, tetrahydropyrimidiniums, piperaziniums, and piperidiniums; and
(iii) nitrogen-containing heterocyclic aromatic cations such as pyridiniums and imidazoliums.

Examples of anions contained in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)−, and C(SO₂CF₃)₃⁻.

The ionic liquid may contain a lithium salt.

In order to improve the adhesion between particles, at least one selected from the group consisting of the positive electrode 201, the electrolyte layer 202, and the negative electrode 203 may contain a binder.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. A copolymer can also be used as the binder. Examples of such a binder include a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from these may be used as the binder.

At least one of the positive electrode 201 and the negative electrode 203 may contain a conductive additive in order to improve electronic conductivity.

Examples of the conductive additive include:
(i) graphites such as a natural graphite and an artificial graphite;
(ii) carbon blacks such as acetylene black and ketjen black;
(iii) conductive fibers such as a carbon fiber and metal fiber;
(iv) fluorinated carbon;
(v) metal powders such as an aluminum powder;
(vi) conductive whiskers such as a zinc oxide whisker and a potassium titanate whisker;
(vii) a conductive metal oxide such as titanium oxide; and
(viii) a conductive polymer compound such as polyaniline compound, polypyrrole compound, and polythiophene compound. To reduce the cost, the conductive additive in (i) or (ii) above may be used.

Instead of the electrolyte layer, a separator impregnated with an electrolyte solution may be used, or a casing in which a positive electrode, a separator portion, and a negative electrode are housed may be filled with an electrolyte solution. The electrolyte solution may be, for example, the nonaqueous electrolyte solution described above. Examples of the shape of the battery according to the second embodiment include a coin type, a cylindrical type, a prismatic type, a sheet type, a button type, a flat type, and a stack type.

The battery according to the second embodiment may be manufactured, for example, by preparing a material for forming a positive electrode, a material for forming an electrolyte layer, and a material for forming a negative electrode, and producing by a known method a stack in which the positive electrode, the electrolyte layer, and the negative electrode are disposed in this order.

### OTHER EMBODIMENTS

### (Additional Notes)

The following techniques are disclosed by the description of the above embodiments.

### (Technique 1)

A halide solid electrolyte containing: Li; Al; M; and X, wherein
the M is at least one element selected from the group consisting of metal elements (excluding Li and Al) and metalloid elements,
the X is at least one selected from the group consisting of F, Cl, Br, and I,
the halide solid electrolyte includes
   a first particle group consisting of first particles made of a compound A containing Al and the X, and
   a second particle group consisting of second particles made of a compound B not containing Al but containing the M and the X,
in the first particle group, a coefficient of variation CV_{Al} obtained by the following mathematical formula (A) using a standard deviation σ_{Al} of a ratio Al/X of a mass of Al to a mass of the X and an average value A_{Al} of the ratio Al/X is 10% or less, and
in the second particle group, a coefficient of variation CV_{M} obtained by the following mathematical formula (B) using a standard deviation σ_{M} of a ratio M/X of a mass of the M to a mass of the X and an average value A_{M} of the ratio M/X is 20% or less,

CV_{Al}=(σ_{Al}/A_{Al})×100, mathematical formula (A):

CV_{M}=(σ_{M}/A_{M})×100. mathematical formula (B):

Owing to the above configuration, a halide solid electrolyte having excellent ionic conductivity can be obtained. Furthermore, owing to the above configuration, a halide solid electrolyte having excellent stability (e.g., heat resistance and atmospheric resistance) and high reliability can be obtained. Therefore, according to the above configuration, a halide solid electrolyte having excellent ionic conductivity and reliability can be obtained.

### (Technique 2)

The halide solid electrolyte according to Technique 1, wherein
the compound A is represented by the following composition formula (1),
the compound B is represented by the following composition formula (2),

Li₃(Al_{1-y1}M_{y1})X₆, composition formula (1):

Li₂MX₆, and composition formula (2):
in the composition formula (1), the y1 satisfies 0≤y1<1.

According to the above configuration, a halide solid electrolyte having further improved reliability can be obtained by a mixed structure of the compound A and the compound B having a high Li ion content and high ionic conductivity.

### (Technique 3)

The halide solid electrolyte according to Technique 2, wherein
the compound A is represented by the following composition formula (3),

Li₃AlX₆. composition formula (3):

According to the above configuration, a halide solid electrolyte having further improved reliability can be obtained by a mixed structure of the compound A and the compound B having a high Li ion content and high ionic conductivity.

### (Technique 4)

The halide solid electrolyte according to Technique 1, wherein
the first particle group includes a particle including a first crystal phase represented by the following composition formula (4) and a second crystal phase represented by the following composition formula (5),

Li₃(Al_{1-y2}M_{y2})X₆ Composition formula (4):

Li₂MX₆, and composition formula (5):
in the composition formula (4), the y2 satisfies 0≤y2<1.

In the above configuration, the first crystal phase and the second crystal phase are included in one particle. By including such particles, a halide solid electrolyte having improved reliability can be obtained.

### (Technique 5)

The halide solid electrolyte according to Technique 4, wherein
in the particle including the first crystal phase and the second crystal phase, a molar ratio of the first crystal phase to a total of the first crystal phase and the second crystal phase is 0.05 or more and 0.95 or less.

According to the above configuration, a halide solid electrolyte having higher ionic conductivity (e.g., 1.0 μS/cm or more) can be obtained.

### (Technique 6)

The halide solid electrolyte according to any one of Techniques 1 to 5, wherein
the X includes F.

According to the above configuration, due to the strong bond between the most electronegative fluoride ion and other cations, a halide solid electrolyte having excellent stability (e.g., electrochemical stability and heat resistance) can be obtained.

### (Technique 7)

The halide solid electrolyte according to any one of Techniques 1 to 6, wherein
the M includes Ti.

Owing to the above configuration, a halide solid electrolyte having higher ionic conductivity can be obtained. In addition, by including Ti, the solid-phase reaction temperature can be lowered (e.g., to 750° C. or lower), that is, an effect of promoting the reaction can be obtained. Therefore, a homogeneous halide solid electrolyte having excellent ionic conductivity can be obtained.

### (Technique 8)

The halide solid electrolyte according to Technique 2 or 3, wherein
the M includes Ti, and
the y1 satisfies 0≤y1≤0.3.

Owing to the above configuration, a halide solid electrolyte having higher ionic conductivity can be obtained.

### (Technique 9)

The halide solid electrolyte according to Technique 4 or 5, wherein
the M includes Ti, and
the y2 satisfies 0≤y2≤0.3.

Owing to the above configuration, a halide solid electrolyte having higher ionic conductivity can be obtained.

### (Technique 10)

The halide solid electrolyte according to Technique 3, wherein
the compound A represented by the composition formula (3) has a monoclinic crystal structure.

Owing to the above configuration, a halide solid electrolyte having higher ionic conductivity (e.g., 1.0 μS/cm or more) can be obtained.

### (Technique 11)

The halide solid electrolyte according to Technique 4, wherein
the first crystal phase has an orthorhombic crystal structure.

Owing to the above configuration, a halide solid electrolyte having higher ionic conductivity (e.g., 3.0 S/cm or more) can be obtained.

### (Technique 12)

The halide solid electrolyte according to Technique 11, wherein
the M includes Ti.

Owing to the above configuration, a halide solid electrolyte having even higher ionic conductivity (e.g., 6.0 μS/cm or more) can be obtained.

### (Technique 13)

The halide solid electrolyte according to any one of Techniques 1 to 12, wherein
the ratio Al/X is equal to or greater than (the average value A_{Al}−3×the standard deviation σ_{Al}) and equal to or less than (the average value A_{Al}+3×the standard deviation σ_{Al}).

Owing to the above configuration, particles having a composition with a low ionic conductivity are reduced, so that a halide solid electrolyte having higher ionic conductivity (e.g., 1.0 μS/cm or more, or 3.0 μS/cm or more) can be obtained.

### (Technique 14)

The halide solid electrolyte according to any one of Techniques 1 to 13, wherein
the ratio M/X is equal to or greater than (the average value A_{M}−3×the standard deviation σ_{M}) and equal to or less than (the average value A_{M}+3×the standard deviation σ_{M}).

Owing to the above configuration, particles having a composition with a low ionic conductivity are reduced, so that a halide solid electrolyte having higher ionic conductivity (e.g., 1.0 μS/cm or more, or 3.0 μS/cm or more) can be obtained.

### (Technique 15)

The halide solid electrolyte according to any one of Techniques 1 to 14, wherein
the ratio Al/X is equal to or greater than (the average value A_{Al}−3×the standard deviation σ_{Al}) and equal to or less than (the average value A_{Al}+3×the standard deviation σ_{Al}), and
the ratio M/X is equal to or greater than (the average value A_{M}−3×the standard deviation σ_{M}) and equal to or less than (the average value A_{M}+3×the standard deviation σ_{M}).

Owing to the above configuration, particles having a composition with a low ionic conductivity are reduced, so that a halide solid electrolyte having higher ionic conductivity (e.g., 1.0 μS/cm or more, or 3.0 μS/cm or more) can be obtained.

### (Technique 16)

The halide solid electrolyte according to any one of Techniques 1 to 15, wherein
at least one particle selected from the group consisting of the first particles and the second particles includes an amorphous phase.

Owing to the above configuration, a halide solid electrolyte that achieves both high ionic conductivity (e.g., 1.0 μS/cm or more) and low electronic conductivity (e.g., 0.01 μS/cm or less) can be obtained. In addition, in the halide solid electrolyte, the amorphous phase portion becomes softer and more easily deformed. Therefore, when the halide solid electrolyte of Technique 16 is made into a compacted powder, an interface where the particles are in close contact with each other is easily formed, the halide solid electrolyte can be highly densified and is easily thinned, and further improvement of the ionic conductivity thereof can also be expected. Therefore, in the case where the halide solid electrolyte according to Technique 16 is used, for example, for a solid electrolyte layer of a battery, thinning of the solid electrolyte layer can be achieved, or the halide solid electrolyte can be suitably used for a coating layer for active material particles.

### (Technique 17)

The halide solid electrolyte according to Technique 16, wherein
a volume of the amorphous phase included in the second particle is larger than a volume of the amorphous phase included in the first particle.

According to the above configuration, the ionic conductivity and the reliability can be further improved. In addition, according to the above configuration, since the halide solid electrolyte becomes softer and more easily deformed, the adhesion between the particles is improved, and the voids between the particles are reduced. Therefore, the halide solid electrolyte according to Technique 17 can be densified when made into a compacted powder. Accordingly, for example, in the case where the halide solid electrolyte is used for a solid electrolyte layer of a battery, the solid electrolyte layer can be densified, or the halide solid electrolyte can be suitably used for a coating layer for active material particles.

### (Technique 18)

The halide solid electrolyte according to Technique 16 or 17, wherein
the amorphous phase included in the first particle has higher ionic conductivity than the amorphous phase included in the second particle.

According to the above configuration, the first particles having higher ionic conductivity can be bonded by the softer second particles, so that high ionic conductivity can be obtained.

### (Technique 19)

The halide solid electrolyte according to any one of Techniques 16 to 18, wherein
the amorphous phase has lower electronic conductivity than portions of the first particle and the second particle excluding the amorphous phase.

When the amorphous phase has lower electronic conductivity (e.g., 0.01 μS/cm or less) than the portion excluding the amorphous phase, a halide solid electrolyte having more excellent ionic conductivity is obtained.

### (Technique 20)

The halide solid electrolyte according to any one of Techniques 1 to 19, being a compacted powder formed from the first particles and the second particles.

According to the above configuration, a solid electrolyte layer of a battery or a coating layer for active material particles that has excellent ionic conductivity and reliability can be realized.

### (Technique 21)

The halide solid electrolyte according to any one of Techniques 1 to 20, wherein
the halide solid electrolyte comprises at least one selected from the group consisting of Nb and Ga.

According to the above configuration, the synthesis reaction from the starting raw materials to the halide solid electrolyte is promoted, so that a halide solid electrolyte having excellent ionic conductivity and reliability can be efficiently obtained.

### (Technique 22)

A positive electrode material including the solid electrolyte according to any one of Techniques 1 to 21.

With the positive electrode material according to Technique 22, a battery having high performance such as excellent charge and discharge characteristics can be realized.

### (Technique 23)

A battery including a positive electrode including the positive electrode material according to Technique 22.

Owing to this configuration, a battery having high performance such as excellent charge and discharge characteristics can be provided.

### (Technique 24)

A battery including:
a positive electrode;
a negative electrode; and
an electrolyte layer provided between the positive electrode and the negative electrode, wherein
at least one selected from the group consisting of the positive electrode, the negative electrode, and the electrolyte layer includes the solid electrolyte according to any one of Techniques 1 to 21.

Owing to this configuration, a battery having high performance such as excellent charge and discharge characteristics can be provided.

Although the solid electrolyte and the production method therefor according to the present disclosure have been described above based on the embodiments, the present disclosure is not limited to these embodiments. The embodiments including various modifications conceived of by a person skilled in the art, and other embodiments configured by combining some of components of the embodiments are also included in the scope of the present disclosure as long as the embodiments do not depart from the gist of the present disclosure.

In the above-described embodiments, various changes, replacements, additions, omissions, or the like can be made within the scope of the claims or the scope equivalent thereto.

### EXAMPLES

Hereinafter, the present disclosure will be described in more detail with reference to an example.

### <Synthesis of Halide Solid Electrolyte>

### Example 1

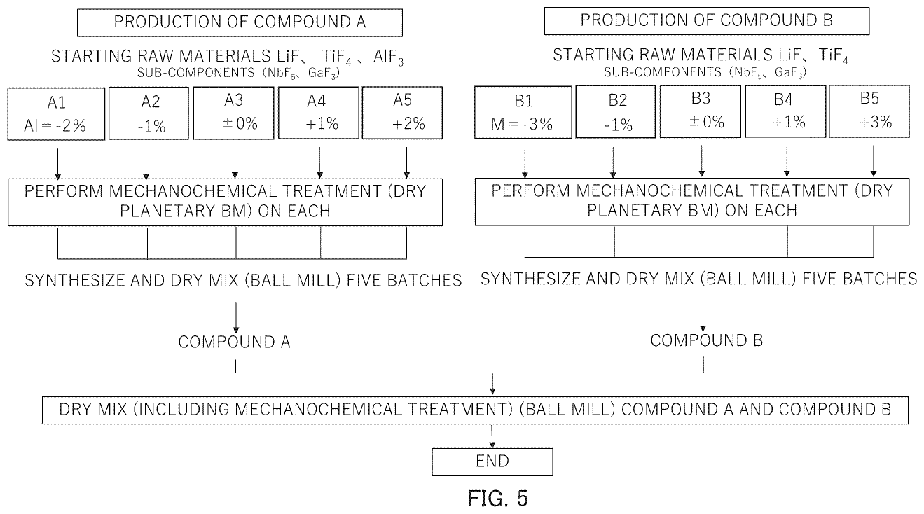

FIG. 5 is a flowchart of a production method for a halide solid electrolyte of Example 1. In Example 1, a halide solid electrolyte in which the compound A constituting each first particle was represented by a composition formula of Li₃(Al_{0.85} Ti_{0.15})F₆ and the compound B constituting each second particle was represented by a composition formula of Li₂TiX₆ was synthesized. That is, in Example 1, M was Ti. In Example 1, a halide solid electrolyte was synthesized such that Li₃(Al_{0.85}Ti_{0.15})F₆, which was the compound A, and Li₂TiX₆, which was the compound B, satisfied Li₃(Al_{0.85}Ti_{0.15})F₆:Li₂TiX₆=0.75:0.25 in molar ratio.

As starting raw materials, chemically high-purity powders of LiF, TiF₄, and AlF₃ were prepared. The first particles made of the compound A and the second particles made of the compound B were produced using these starting raw materials.

As for the production of the first particles, first, five batches A1, A2, A3, A4, and A5 were preliminarily synthesized such that an average composition became a target compound A composition Li₃(Al_{0.85}Ti_{0.15})F₆ and Al components thereof were slightly different from each other.

In the batch Al, the starting raw materials were mixed so as to have a composition having Al at −2% from the target compound A composition Li₃(Al_{0.85} Ti_{0.15})F₆, that is, such that the mixing ratio of the starting raw materials was a ratio in which Al was reduced by 2% in molar ratio compared to the amount of Al charged in the case where Li₃(Al_{0.85}Ti_{0.15})F₆ was a target.

In the batch A2, the starting raw materials were mixed so as to have a composition having Al at −1% from the target compound A composition Li₃(Al_{0.85} Ti_{0.15})F₆, that is, such that the mixing ratio of the starting raw materials was a ratio in which Al was reduced by 1% in molar ratio compared to the amount of Al charged in the case where Li₃(Al_{0.85} Ti_{0.15})F₆ was a target.

In the batch A3, the starting raw materials were mixed at a ratio that achieved the target compound A composition Li₃(Al_{0.85} Ti_{0.15})F₆. That is, in the batch A3, the change in A1 from the target compound A composition Li₃(Al_{0.85} Ti_{0.15})F₆ was 0%.

In the batch A4, the starting raw materials were mixed so as to have a composition having Al at +1% from the target compound A composition Li₃(Al_{0.85} Ti_{0.15})F₆, that is, such that the mixing ratio of the starting raw materials was a ratio in which Al was increased by 1% in molar ratio compared to the amount of Al charged in the case where Li₃(Al_{0.85} Ti_{0.15})F₆ was a target.

In the batch A5, the starting raw materials were mixed so as to have a composition having Al at +2% from the target compound A composition Li₃(Al_{0.85} Ti_{0.15})F₆, that is, such that the mixing ratio of the starting raw materials was a ratio in which Al was increased by 2% in molar ratio compared to the amount of Al charged in the case where Li₃(Al_{0.85} Ti_{0.15})F₆ was a target.

In each of the batches Al to A5, 30 g of a mixed powder of the starting raw materials was weighed in a normal atmospheric environment, and preliminary synthesis was performed for 10 hours by dry mechanochemical treatment using a planetary ball mill having a capacity of 300 mL (using zirconia balls having a diameter of 1 mm). The obtained preliminarily synthesized products A1, A2, A3, A4, and A5 were combined in amounts of 5 g, respectively, were placed in a 600-mL ball mill having a zirconia inner wall together with 5-mm zirconia balls, and were dry mixed for 20 hours. Accordingly, the first particles were obtained. The first particles had an average particle diameter of about 0.7 μm. The average particle diameter of the first particles was obtained by the intercept method for a scanning electron microscope (SEM) image of the first particles (magnification: 2000×).

As for the production of the second particles, first, five batches B1, B2, B3, B4, and B5 were preliminarily synthesized such that an average composition became a target compound B composition Li₂TiX₆ and Ti components thereof were slightly different from each other.

In the batch B1, the starting raw materials were mixed so as to have a composition having Ti at −3% from the target compound B composition Li₂TiX₆, that is, such that the mixing ratio of the starting raw materials was a ratio in which Ti was reduced by 3% in molar ratio compared to the amount of Ti charged in the case where Li₂TiX₆ was a target.

In the batch B2, the starting raw materials were mixed so as to have a composition having Ti at −1% from the target compound B composition Li₂TiX₆, that is, such that the mixing ratio of the starting raw materials was a ratio in which Ti was reduced by 1% in molar ratio compared to the amount of Ti charged in the case where Li₂TiX₆ was a target.

In the batch B3, the starting raw materials were mixed at a ratio that achieved the target compound B composition Li₂TiX₆. That is, in the batch B3, the change in Ti from the target compound B composition Li₂TiX₆ was 0%.

In the batch B4, the starting raw materials were mixed so as to have a composition having Ti at +1% from the target compound B composition Li₂TiX₆, that is, such that the mixing ratio of the starting raw materials was a ratio in which Ti was increased by 1% in molar ratio compared to the amount of Ti charged in the case where Li₂TiX₆ was a target.

In the batch B5, the starting raw materials were mixed so as to have a composition having Ti at +3% from the target compound B composition Li₂TiX₆, that is, such that the mixing ratio of the starting raw materials was a ratio in which Ti was increased by 3% in molar ratio compared to the amount of Ti charged in the case where Li₂TiX₆ was a target.

In each of the batches B1 to B5, 30 g of a mixed powder of the starting raw materials was weighed in a normal atmospheric environment, and preliminary synthesis was performed for 10 hours by dry mechanochemical treatment using a planetary ball mill having a capacity of 300 mL (using zirconia balls having a diameter of 1 mm). The obtained preliminarily synthesized products B1, B2, B3, B4, and B5 were combined in amounts of 5 g, respectively, were placed in a 600-mL ball mill having a zirconia inner wall together with 5-mm zirconia balls, and were dry mixed for 20 hours. Accordingly, the second particles were obtained. The second particles had an average particle diameter of approximately 0.66 μm. The average particle diameter of the second particles was obtained by the intercept method for an SEM image of the second particles (magnification: 2000×).

Next, the first particles (i.e., compound A) and the second particles (i.e., compound B) were weighed and mixed such that Li₃(Al_{0.85} Ti_{0.15})F₆, which was the compound A, and Liz TiX₆, which was the compound B, satisfied Li₃(Al_{0.85} Ti_{0.15})F₆:Li₂TiX₆=0.75:0.25 in molar ratio and the total thereof was 30 g. The first particles and the second particles were placed in a 600-mL ball mill having a zirconia inner wall together with 5-mm zirconia balls, and were dry mixed for 20 hours, and the mixed powder was collected as a halide solid electrolyte of Example 1. By this dry ball milling treatment including mechanochemical treatment, amorphization also proceeded simultaneously with the synthesis of the halide solid electrolyte. That is, the obtained halide solid electrolyte of Example 1 included an amorphous phase.

### Comparative Example 1

A halide solid electrolyte was synthesized in the same manner as for the solid electrolyte material of the example described in Patent Literature 1. That is, fluorides were used as the starting raw materials, and a halide solid electrolyte of Comparative Example 1 was produced by mechanochemical synthesis. Specifically, LiF, TiF₄, and AlF₃ were prepared to have a molar ratio of LiF:TiF₄:AlF3=2.75:0.25:0.75. 30 g of a mixture of these materials was placed in a planetary ball mill having a capacity of 500 mL together with 200 g of φ5-mm zirconia balls in an Ar atmosphere, and the mill was sealed. Then, mechanochemical milling treatment was performed for 12 h at 500 rpm in the planetary ball mill. Thus, a solid electrolyte of Comparative Example 1 was synthesized. The synthesized product was taken out and collected in an Ar atmosphere.

### <Evaluation of Solid Electrolyte>

For the halide solid electrolytes of Example 1 and Comparative Example 1 synthesized as described above, the ionic conductivity, the electronic conductivity, the coefficient of variation CV_{Al}, and coefficient of variation CV_{M} were obtained.

### (Ionic Conductivity)

For the ionic conductivity, a powder of the halide solid electrolyte was placed in a mold having a diameter of 10 mm, and a compacted powder sample was obtained by applying a pressure of about 3 t/cm using a single-axis hydraulic press. The ionic conductivity was calculated from the area, the thickness, and the impedance characteristics at room temperature of the compacted powder sample. The impedance measurement was performed at room temperature with pressure applied. The impedance measurement was performed at a measurement frequency of 10 Hz to 10 MHz, a measurement voltage of 1 Vrms, and no DC bias. The deviation between the electrical lengths of a cable and a measurement jig was offset upon evaluation. The ionic conductivity of the halide solid electrolyte of Example 1 was 7.1 μS/cm, and the ionic conductivity of the halide solid electrolyte of Comparative Example 1 was 0.93 μS/cm.

### (Electronic Conductivity)

The electronic conductivity was calculated from a DC voltage and current characteristics. The electronic conductivity of the halide solid electrolyte of Example 1 was <0.01 μS/cm. The electronic conductivity of the halide solid electrolyte of Comparative Example 1 was 0.017 μS/cm.

(Coefficient of Variation CV_{Al} and Coefficient of Variation CV_{M})

For the halide solid electrolyte obtained in Example 1 and the halide solid electrolyte obtained in Comparative Example 1, the coefficient of variation CV_{Al} and the coefficient of variation CV_{M} were obtained by the following method.

First, a compacted powder sample of the halide solid electrolyte was produced in the same manner as the compacted powder sample produced in the measurement of the ionic conductivity. For this compacted powder sample, a cross-section of the compacted powder sample was formed using a cross-section polisher (CP). For this cross-section, elemental analysis (spot analysis) with EPMA was performed for a plurality of arbitrary spots with a spot diameter of 1 μm. By the elemental analysis with EPMA, the spots were divided into spots identified as the first particles and spots identified as the second particles, 20 spots were arbitrarily selected from the spots identified as the first particles, and 20 spots were arbitrarily selected from the spots identified as the second particles. Using the elemental analysis results of the arbitrary 20 spots measured as the first particles, the standard deviation σ_{Al} and the average value A_{Al} of the ratio Al/X were obtained, and the coefficient of variation CV_{Al} was calculated. Using the elemental analysis results of the arbitrary 20 spots measured as the second particles, the standard deviation σ_{M} and the average value A_{M} of the ratio M/X were obtained, and the coefficient of variation CV_{M} was calculated.

For the halide solid electrolyte obtained in Example 1, the standard deviation σ_{Al} was 0.01013, the average value A_{Al} was 0.1512, the coefficient of variation CV_{Al} was 6.7%, the standard deviation σ_{M} was 0.01683, the average value A_{M} was 0.1503, and the coefficient of variation CV_{M} was 11.2%.

For the halide solid electrolyte obtained in Comparative Example 1, the standard deviation σ_{Al} was 0.02084, the average value A_{Al} was 0.1408, the coefficient of variation CV_{Al} was 14.8%, the standard deviation σ_{M} was 0.03711, the average value A_{M} was 0.139, and the coefficient of variation CV_{M} was 26.7%.

As described above, the halide solid electrolyte of Example 1 for which the coefficient of variation CV_{Al} was 10% or less and the coefficient of variation CV_{M} was 20% or less had a higher ionic conductivity than the halide solid electrolyte of Comparative Example 1 for which the coefficient of variation CV_{Al} was greater than 10% and the coefficient of variation CV_{M} was greater than 20%.

### INDUSTRIAL APPLICABILITY

The halide solid electrolyte according to the present disclosure can be used, for example, as a solid electrolyte for secondary batteries such as all-solid-state batteries for use in various electronic devices or automobiles.

What is claimed is:

1. A halide solid electrolyte comprising:
Li;
Al;
M; and
X, wherein
the M is at least one element selected from the group consisting of metal elements (excluding Li and Al) and metalloid elements,
the X is at least one selected from the group consisting of F, Cl, Br, and I,
the halide solid electrolyte includes
a first particle group consisting of first particles made of a compound A containing Al and the X, and
a second particle group consisting of second particles made of a compound B not containing Al but containing the M and the X
in the first particle group, a coefficient of variation CV_{Al} obtained by the following mathematical formula (A) using a standard deviation σ_{Al} of a ratio Al/X of a mass of Al to a mass of the X and an average value A_{Al} of the ratio Al/X is 10% or less, and
in the second particle group, a coefficient of variation CV_{M} obtained by the following mathematical formula (B) using a standard deviation σ_{M} of a ratio M/X of a mass of the M to a mass of the X and an average value A_{M} of the ratio M/X is 20% or less,
CV_{Al}=(σ_{Al}/A_{Al})×100, mathematical formula (A):
CV_{M}=(σ_{M}/A_{M})×100. mathematical formula (B):

2. The halide solid electrolyte according to claim 1, wherein
the compound A is represented by the following composition formula (1),
the compound B is represented by the following composition formula (2),
Li₃(Al_{1-y1}M_{y1})X₆, composition formula (1):
Li₂MX₆, and composition formula (2):
in the composition formula (1), the y1 satisfies 0≤y1<1.

3. The halide solid electrolyte according to claim 2, wherein
the compound A is represented by the following composition formula (3),
Li₃AlX₆. composition formula (3):

4. The halide solid electrolyte according to claim 1, wherein
the first particle group includes a particle including a first crystal phase represented by the following composition formula (4) and a second crystal phase represented by the following composition formula (5),
Li₃(Al_{1-y2}M_{y2})X₆, composition formula (4):
Li₂MX₆, and composition formula (5):
in the composition formula (4), the y2 satisfies 0≤y2<1.

5. The halide solid electrolyte according to claim 4, wherein
in the particle including the first crystal phase and the second crystal phase, a molar ratio of the first crystal phase to a total of the first crystal phase and the second crystal phase is 0.05 or more and 0.95 or less.

6. The halide solid electrolyte according to claim 1, wherein
the X includes F.

7. The halide solid electrolyte according to claim 1, wherein
the M includes Ti.

8. The halide solid electrolyte according to claim 2, wherein
the M includes Ti, and
the y1 satisfies 0≤y1≤0.3.

9. The halide solid electrolyte according to claim 4, wherein
the M includes Ti, and
the y2 satisfies 0≤y2≤0.3.

10. The halide solid electrolyte according to claim 3, wherein
the compound A represented by the composition formula (3) has a monoclinic crystal structure.

11. The halide solid electrolyte according to claim 4, wherein
the first crystal phase has an orthorhombic crystal structure.

12. The halide solid electrolyte according to claim 11, wherein
the M includes Ti.

13. The halide solid electrolyte according to claim 1, wherein
the ratio Al/X is equal to or greater than (the average value A_{Al}−3×the standard deviation σ_{Al}) and equal to or less than (the average value A_{Al}+3×the standard deviation σ_{Al}).

14. The halide solid electrolyte according to claim 1, wherein
the ratio M/X is equal to or greater than (the average value A_{M}−3×the standard deviation σ_{M}) and equal to or less than (the average value A_{M}+3×the standard deviation σ_{M}).

15. The halide solid electrolyte according to claim 1, wherein
the ratio Al/X is equal to or greater than (the average value A_{Al}−3×the standard deviation σ_{Al}) and equal to or less than (the average value A_{Al}+3×the standard deviation σ_{Al}), and
the ratio M/X is equal to or greater than (the average value A_{M}−3×the standard deviation σ_{M}) and equal to or less than (the average value A_{M}+3×the standard deviation σ_{M}).

16. The halide solid electrolyte according to claim 1, wherein
at least one particle selected from the group consisting of the first particles and the second particles includes an amorphous phase.

17. The halide solid electrolyte according to claim 1, wherein
the halide solid electrolyte comprises at least one selected from the group consisting of Nb and Ga.

18. A positive electrode material comprising the halide solid electrolyte according to claim 1.

19. A battery comprising a positive electrode including the positive electrode material according to claim 18.

20. A battery comprising:
a positive electrode;
a negative electrode; and
an electrolyte layer provided between the positive electrode and the negative electrode, wherein
at least one selected from the group consisting of the positive electrode, the negative electrode, and the electrolyte layer includes the halide solid electrolyte according to claim 1.
